(19) United States
(12) Patent Application Publication
(10) Pub. No.: US 2008/0124032 A1
(43) Pub. Date: May 29, 2008

(54) System and Method of Protecting Optical Cables

(76) Inventors: Christopher Horvath, Irvine, CA (US); Bruno X. Lassalas, Irvine, CA (US)

Correspondence Address: ALCON, IP LEGAL, TB4-8, 6201 SOUTH FREEWAY, FORT WORTH, TX, 76134, US

(21) Appl. No.: 11/736,407

(22) Filed: Apr. 17, 2007

Related U.S. Application Data
(60) Provisional application No. 60/795,737, filed on Apr. 28, 2006.

(51) Int. Cl. G02B 6/44

(52) U.S. Cl. 385/76

(57) ABSTRACT

Embodiments of the present invention provide an optical connection that protects the optical fiber or cable. This optical connection includes an optical coupling to communicatively couple an optical fiber to an optical device. A mechanical guide receives the optical fiber proximate to the optical device. This mechanical guide prevents excessive or limits the amount of bending of individual optical fibers or cable proximate to the optical device. This may be achieved by receiving the optical fiber within a mechanical guide having a predetermined bend radius based on the optical fiber or optical cable running inside. By limiting the potential for excessive bending of an optical fiber proximate to an optical coupling the potential for attenuation of the transmitted light within the fiber due to extreme bending is decreased.

### CROSS REFERENCE TO RELATED APPLICATION

This application claims priority under 35 U.S.C. § 119 to U.S. Provisional Patent Application No. 60/795,737 filed Apr. 28, 2006, the entire contents of which are incorporated herein by reference.

### TECHNICAL FIELD OF THE INVENTION

The present invention relates generally to optical cables, and more particularly, to a system and method of protecting an optical cable coupled to a device.

### BACKGROUND OF THE INVENTION

Optical cables, which may include one or more optical fibers, are used in a wide variety of applications. These optical pathways may be used to carry large volumes of data over great distances, for example, or to efficiently transmit light from a light source to an area of interest. Optical fibers and cables are produced using precision manufacturing techniques and require exacting standards. Optical fiber can be thought of as a finely tuned instrument requiring care in production, handling, installation and use.

FIG. 1 depicts a cross-section of a typical optical fiber 10 having three main components. These components include: core 12, which carries the light to be transported within the optical pathway; cladding 14, which surrounds the core and typically has a lower refractive index in order to contain the light within core 12; and coating 16, which protects the fragile fiber within. Core 12 is the smallest and most fragile part of the optical fiber. The optical core 12 is usually made of a glass or other like transparent material that is extremely pure. An extremely clear core 12 is required to minimize transmission losses within the optical fiber 10. Cladding 14 surrounds and protects core 12. Coating 16, which may be made of a plastic, acrylic or other like material, absorbs shocks, nicks, scrapes and even moisture to prevent damage to the cladding 14 and core 12. Without the coating 16, the optical fiber 10 is extremely fragile. Coating 16 is typically only protective and does not contribute to the light carrying ability of the optical fiber 10. Despite the presence of the Coating 16 around the optical fiber core 12, optical fibers may frequently be bent and damaged where they optically couple with a laser or other component.

FIG. 2 shows a typical unprotected optical fiber cable 24 that may be easily bent such that the bending will cause damage to the core. To avoid damage caused by bending the fiber cable 24, a strain relief 22 is present on the optical cable 24 approximate to a mechanical coupling 26 that facilitates the optical and mechanical coupling of the optical fiber 24 to a second optical device. Strain relief 22 is typically straight and not suited to a specific device or application. Additionally, some optical cables have been protected with a strain relief device that covers the entire length of the cable. This results in increased weight and decreased flexibility of the cable.

The simplest type of optical cable is cordage and is used in connection with equipment and patch panels. The major difference between cordage and cables is that typically cordage has only one fiber buffer combination within the jacket, whereas optical cables generally have multiple fibers within a single jacket or multiple cords inside an outer jacket or sheath.

Optical cables typically include two or more optical fibers that have been bundled within a single cable. These cables may be used for data communications, imaging or the transmission of light. The type of signal being carried and the number of optical fibers within the optical cable are just two of the many considerations when selecting a cable for a specific application. Other factors may include tensile strength, temperature resistance, ruggedness, environmental extremes, appearance, durability and flexibility. The exact combination of these factors varies depending on the specific use of the optical cable to be installed.

An individual optical fiber within a cable may be contained within a buffer. A buffer surrounds the cable and provides a greater measure of protection as well as some tensile strength which may be useful when pulling the optical cable or when the cable is suspended. The buffering of an individual cable consists of a buffering layer that surrounds a number of individual fibers. Optical fibers may be loosely buffered or tightly buffered. Loose buffering allows the fiber room to move independently of the buffer and the rest of the cable. This is important when a cable may be subjected to extreme temperatures or excessive bending.

The optical fiber's light carrying abilities are threatened by poor handling, damage from tools or accidents, and improper installation procedures that can damage or bend individual fibers. Extreme bending can severely increase attenuation within an optical fiber. When a fiber is bent too far, light no longer reflects off the boundary between the core and the cladding but passes through and is absorbed within the cladding and coating. To reduce the risk of excessive bending, standards have been set for the installation of optical fiber cable. These standards state that the bend radius for optical fiber should not be less than what is recommended by the manufacturer. This is an appropriate solution where cables are installed but not actively positioned during the use of the cable.

### SUMMARY OF THE INVENTION

The present invention provides a protected optical cable that substantially addresses the above identified needs as well as other needs. More specifically, embodiments of the present invention provide protected optical cables and optical connections by providing a protective guide that protects the optical cable and fiber therein as the optical cable mechanically and optically couples to a second optical device.

Embodiments of the present invention provide an optical connection that protects the optical fiber or cable. This optical connection includes an optical coupling to communicatively couple an optical fiber to an optical device. A mechanical guide receives the optical fiber proximate to the optical device. This mechanical guide prevents excessive bending or limits the amount of bending of individual optical fibers or cable proximate to the optical device. This may be achieved by receiving the optical fiber within a mechanical guide having a predetermined bend radius based on the optical fiber or optical cable running inside.

This type of optical connection may prevent damage to the optical fibers' light carrying abilities during the installation of static optical devices as well as inadvertent damage due to poor handling of portable optical devices. By limiting the potential for excessive bending of an optical fiber proximate to an optical coupling, the potential for attenuation within the fiber due to extreme bending is decreased.

Another embodiment of the present invention provides an optical device such as, but not limited, to a slit lamp, a laser source, or a second optical cable, wherein the optical device includes an optical coupling and a mechanical guide. The optical coupling optically and mechanically couples to a first optical cable, then the optical coupling allows light fed from or to the optical device to be handled internally within the optical device. The mechanical guide may be mounted on the optical device or may be mounted on the optical cable. In either case, this is done proximate to the optical coupling. The mechanical guide prevents excessive bending of the optical cable proximate to the device. For example, when the optical device is a second optical cable, mechanical guides at the optical coupling prevent excessive kinking and bending of the optical cables at the connection.

Yet another embodiment provides a method of coupling optical cables. This method involves optically coupling a first optical cable to an optical coupling. A mechanical guide may be coupled either to the optical coupling or a connector at the end of the first optical cable. In either case, the mechanical guide receives the optical cable and limits any bending thereof The optical coupling couples the optical cable to a second optical device. Excessive bending of the optical cable proximate to the optical device is prevented by limiting the bend radius of the optical cable within the mechanical guide.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts the internal construction of a typical optical fiber;

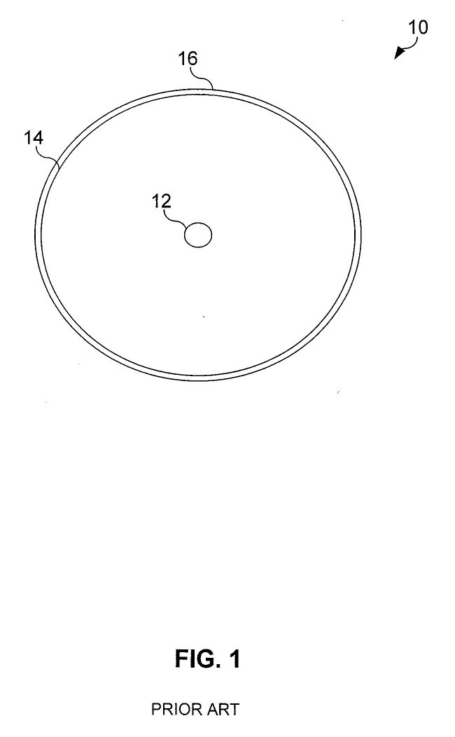

FIG. 2 shows a typical unprotected fiber cable that may be easily bent causing damage to the core;

FIG. 3 shows how an Optical Fiber within a loose tube may be isolated from movement of the cable as a whole;

FIG. 4 depicts an optical connection in accordance with an embodiment of the present convention;

FIG. 5 depicts how excessive bending might occur proximate to an optical cable having a traditional strain relief;

FIG. 6 provides a more detailed view of the mechanical guide in accordance with an embodiment of the present invention;

FIG. 7 depicts an optical device that uses an optical cable protected in accordance with an embodiment of the present invention;

FIG. 8 depicts an embodiment of the present invention wherein an optical connection between two optical cables is protected by mechanical guides in order to prevent excessive bending of the optical cables in accordance with an embodiment of the present invention; and

FIG. 9 provides a logic flow diagram that describes a method of coupling optical cables in accordance with an embodiment of the present invention.

### DETAILED DESCRIPTION OF THE INVENTION

Preferred embodiments of the present invention are illustrated in the FIGUREs, like numerals being used to refer to like and corresponding parts of the various drawings.

Embodiments of the present invention protect optical cables and optical connections by providing a protective mechanical guide that protects the optical cable and fiber therein from excessive bending. This guide facilitates the ability to optically and mechanically couple the optical fibers to an additional optical device. For example, an optical fiber may be connected to a slit lamp when the optical fiber is used to provide laser light from the slit lamp to its intended destination.

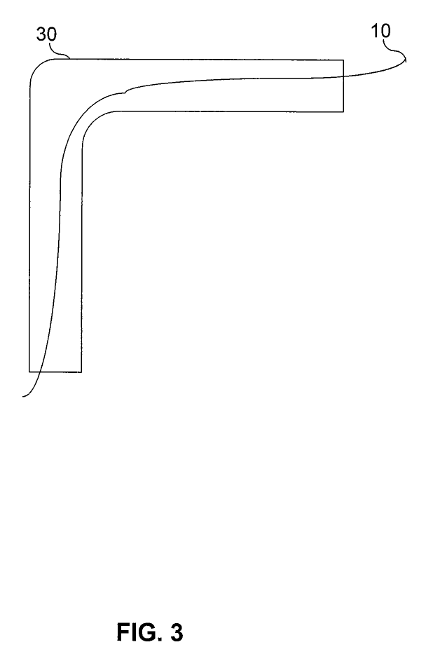

FIG. 3 shows an optical fiber 10 inside a loose tube 30. This arrangement allows the optical fiber 10 to be isolated from movement in the rest of the cable. Because the optical fiber 10 is not connected to the tube 30, the optical fiber 10 will follow a gently meandering path through the tube 30 and in so doing provide some additional strength. This idea is applied to the optical cable as a whole with the addition of the mechanical protective guide provided in accordance with embodiments of the present invention.

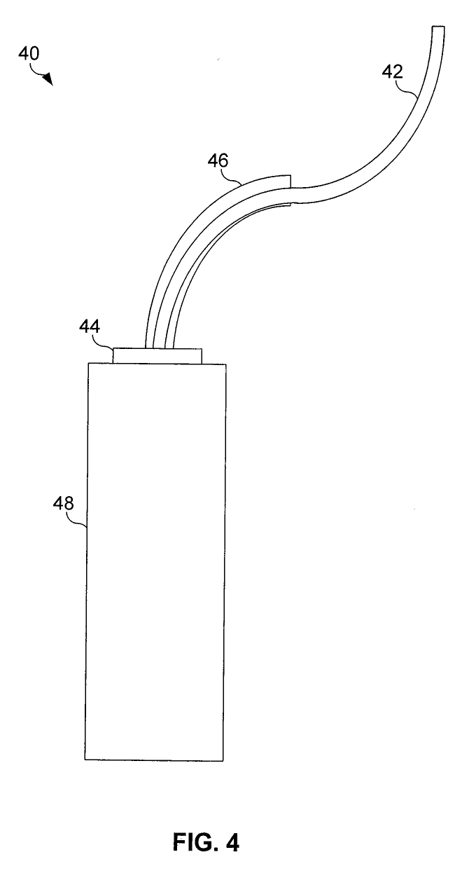

FIG. 4 depicts an optical connection in accordance with an embodiment of the present convention. This optical connection protects an optical cable from excessive bending. As shown here, optical connection 40 includes optical cable 42, optical coupling 44, mechanical guide 46, and optical device 48. Optical coupling 44 communicatively couples optical cable 42 to optical device 48. Mechanical guide 46, which may be mounted on optical coupling 44, optical device 48 or optical cable 42, receives optical cable 42. The method with which the cable is received within the shaped mechanical guide allows light to be efficiently exchanged between the optical cable and optical devices without unnecessary attenuation losses caused by bending of the optical fibers within the optical cable 42.

Additionally, mechanical guide 46 may assist in aligning the optical fiber to the optical device 48 or mechanical guide 46 in order to limit optical losses. In fiber optics, any optical connection is potentially the weakest link. Properly performed, the connection may attenuate the signal only slightly. However, poorly made connections can leak light, reflect the signal back down the transmission path, or separate completely, requiring expensive troubleshooting and repair. A properly made connection is a direct connection between two optical fiber ends. Unlike electrical connections, which only require firm, clean contact between two pieces of wire, optical fiber connections require a great deal of precision and careful preparation of the fiber ends if they are to be connected properly. The fiber cores must align precisely to prevent any loss of light across a connection. Considering the size of the fibers in use, the mechanical guide may align the fiber cores with each other and prevent misalignment of the fiber cores when stress is placed on the optical fiber.

There are a number of factors that can work against a good optical connection. These factors include intrinsic factors if they relate to the structure of the fiber, and extrinsic factors, which concern the relationship of one fiber to another. Intrinsic factors arise from the fact that when the fibers are manufactured, there are still slight variations from one fiber to another, which can cause mismatches between two fiber ends. These may be a numerical aperture mismatch, core diameter mismatch, a clouding diameter mismatch, concentricity loss, or electrical loss. Extrinsic factors cause attenuation in a connection related to the condition of the connection itself. In short, a well made connection causes minimal attenuation, especially when compared to a poorly made connection.

In an ideal connection, fiber core faces are perfectly centered on each other and the cores' axes are perpendicular to the fiber faces being joined. In addition, the optical fiber ends should be in firm contact. Any variation of these conditions may cause attenuation or complete loss of signal. Lateral displacement results from the offset of the center axes of the fiber cores being coupled. As lateral displacement increases, less light can be transmitted between coupled fibers. End separation can result even when coupled fibers are perfectly aligned, resulting in a loss through end separation where a gap exists between the two fibers. End separation can cause gap loss in different ways, for example, through Fresnel reflections. As previously stated, an ideal connection requires the end (faces) or fibers being coupled to be perpendicular to the corresponding fiber core axis and that the fiber faces meet exactly (concentrically) so the fiber cores will line up with one another. If the fiber faces meet at an angle, the transmitted signal will suffer losses from angular misalignment. The solution to these types of extrinsic losses is to properly prepare the ends of fibers to be coupled, making sure that both fiber ends are perpendicular to their respective fiber center axis and that the fibers are in line with one another during splicing.

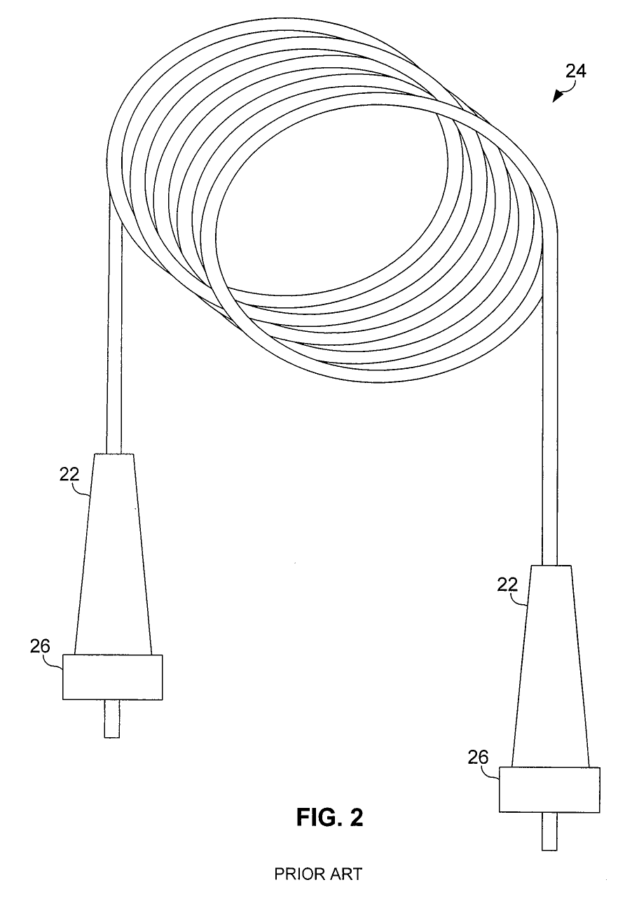

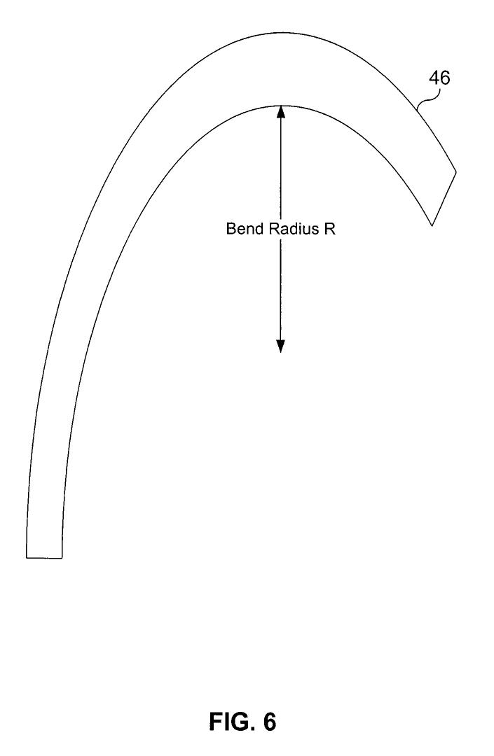

One should note that mechanical guide 46 may take the place of a strain relief 22 as seen in FIG. 2. Mechanical guide 46 prevents excessive bending of the optical cable 42 as the optical cable 42 exits mechanical guide 46. The size and shape of the mechanical guide 46 may be determined with reference to FIG. 6 and its associated discussion.

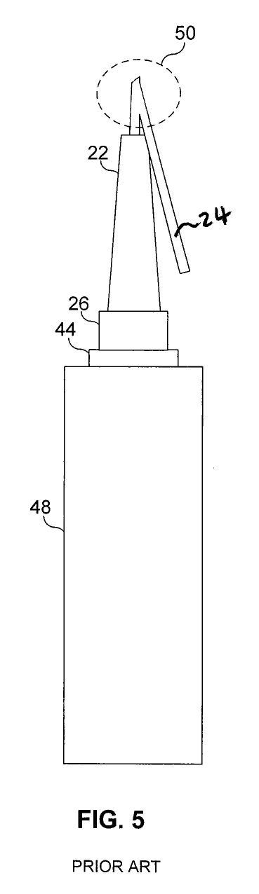

FIG. 5 depicts how excessive bending might occur proximate to an optical cable having a traditional strain relief. In FIG. 5, an optical device 48 is coupled to an optical cable 24 having traditional strain relief 22. As shown in area 50, excessive bending may occur at the end of strain relief 22 where the optical cable 24 bends under its own weight. This may result in damage of the one or more optical fibers being pinched within the optical cable 24. Such positioning may result in attenuation that can cause loss of light transmitted via the optical cable 24 and any information contained therein.

FIG. 6 provides a more detailed view of a mechanical guide 46 according to the teachings of this invention. Here mechanical guide 46 has a bend radius R. This bend radius is sized to prevent damage to an optical cable within the mechanical guide 46. The bend radius may be determined by Standards for Optical Fiber Cable Bending, such as TIA/EIA-568-B.3. For example, when installed in a building, the bend radius' of the optical fibers may be set to a radius no less than 10 (ten) times the outside diameter of the cable under a no-load condition, and not less than 15 (fifteen) times the diameter of the cable under a tensile load or stress condition. Other standards specify a bend radius of not less than ten times the cable outside diameter cable under no-load conditions, and not less than twenty times the cable outside diameter under tensile load or stress conditions when optical cables are run in an unprotected environment. Similar standards may be chosen for portable devices subject to rapid movements in any direction.

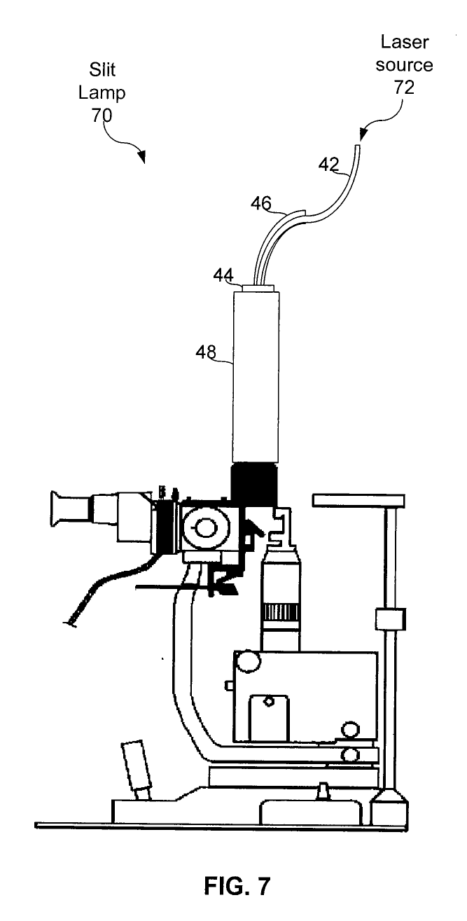

FIG. 7 depicts an optical device such as, but not limited to, a slit lamp, such as the ALCON SL1000, manufactured by Alcon Laboratories, Inc. of Irvine, Calif., that uses an optical cable protected in accordance with an embodiment of the present invention. As shown in FIG. 7, slit lamp 70, or other like optical device, may be coupled to a laser source 72, where the laser light is provided via optical cable 42 and received by optical device 48 through optical connection 44 and mechanical guide 46, for example, as described with reference to FIG. 4.

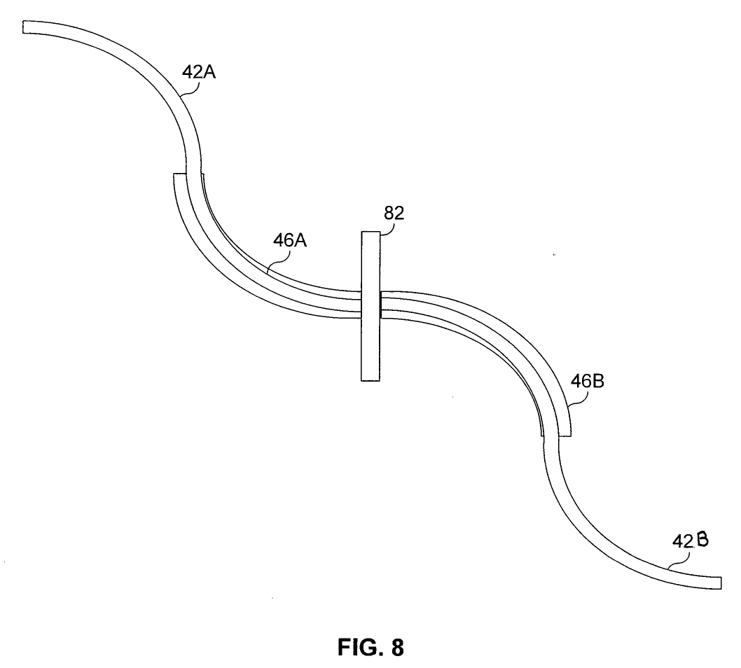

FIG. 8 depicts an embodiment of the present invention wherein an optical connection between two optical cables 42A and 42B is protected by mechanical guides 6A and 46B. This protection prevents excessive bending of the optical cables 42A/42B. Mechanical guides 46A and 46B may be coupled directly to optical cables 42A and 42B, respectively, or they may be part of optical coupling 82. The mechanical guides 46A and 46B receive their respective optical cables and prevent excessive bending at the coupling of the two optical cables 42A and 42B.

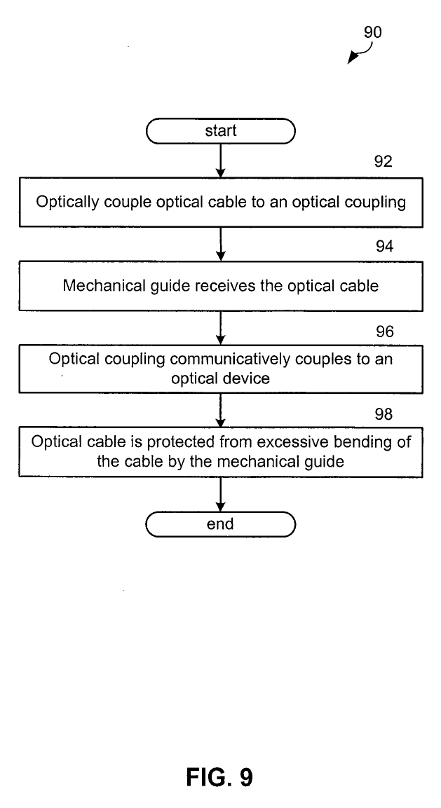

FIG. 9 provides a logic flow diagram of the steps of a method of coupling an optical cable in accordance with an embodiment of the present invention. Processes 90 begin with Step 92 by optically coupling a first optical cable, such as optical cable 42 described in the previous FIGs., to an optical coupling. In Step 94, a mechanical guide couples to the optical coupling wherein the mechanical guide receives the optical cable. In Step 96, the optical coupling communicatively couples to a second optical device, such as but note limited to a laser light source, a slit lamp, or a second optical cable. In Step 98, a connection is protected from excessive bending of the optical cable proximate to the optical device by limiting the bend radius of the optical cable with the mechanical guide.

The mechanical guides discussed above may take any shape that conforms to the bend radius requirements while still providing protection to the optical cables. Unlike prior strain relief's, the mechanical guide, provided in accordance with embodiments of the present invention, may be customized for specific adaptation to optical devices or connections, and may provide more mechanical support than a standard strain relief. Additionally, the embodiments of this invention provide protection that is more efficient than a standard cable protection shield that covers the entire length of a cable, which increases the weight and cost of the cable while decreasing the flexibility.

In summary, the embodiments of the present invention provide a protective mechanical guide that may be used to protect optical cables and fibers from excessive bending. An optical connection includes an optical coupling to communicatively couple an optical fiber to an optical device. A mechanical guide receives the optical fiber proximate to the optical device. This mechanical guide prevents excessive, or limits the amount of, bending of individual optical fibers or cables proximate to the optical device. This may be achieved by receiving the optical fiber within a mechanical guide having a predetermined bend radius based on the optical fiber or optical cable running inside. By limiting the potential for excessive bending of an optical fiber proximate to an optical coupling the potential for attenuation of the transmitted light within the fiber due to extreme bending is decreased.

Although the present invention is described in detail, it should be understood that various changes, substitutions and alterations can be made hereto without departing from the spirit and scope of the invention as claimed in the appended claims.

What is claimed is:

1. An optical connection operable to protect an optical cable, comprising:
an optical coupling operable to communicatively couple an optical cable to an optical device; and
a mechanical guide, mechanically coupled to the optical device, operable to receive the optical cable wherein the mechanical guide prevents excessive bending of the optical cable proximate to the optical device.

2. The optical connection of claim 1, wherein a bend radius for the mechanical guide is not less than 20 times an outside diameter of the optical cable.

3. The optical connection of claim 1, wherein a bend radius for the mechanical guide is not less than 20 times an outside diameter of the optical cable when the optical cable is under a tensile load condition.

4. The optical connection of claim 1, wherein a bend radius for the mechanical guide is not less than 15 times an outside diameter of the optical cable when the optical cable is under a tensile load condition.

5. The optical connection of claim 1, wherein a bend radius for the mechanical guide is not less than 10 times an outside diameter of the optical cable when the optical cable is under a no load condition.

6. The optical connection of claim 1, wherein the optical device comprises a slit lamp.

7. The optical connection of claim 1, the optical cable comprises an optical fiber.

8. The optical connection of claim 1, the optical cable comprises a plurality of optical fibers.

9. The optical connection of claim 1, the optical cable conducts laser light.

10. An optical device, comprising:
an optical coupling operable to communicatively couple an optical cable to the optical device;
a mechanical guide proximate to the optical coupling, wherein the mechanical guide receives the optical cable; and
wherein the mechanical guide prevents excessive bending of the optical cable proximate to the optical device.

11. The optical device of claim 10, further comprising a laser source having a laser light output coupled to the optical coupling.

12. The optical device of claim 10, wherein a bend radius for the mechanical guide is:
not less than 20 times an outside diameter of the optical cable when the optical cable is under a tensile load condition; and
less than 10 times an outside diameter of the optical cable when the optical cable is under a no load condition.

13. The optical device of claim 10, wherein the optical device comprises a slit lamp.

14. The optical device of claim 10, the optical cable comprises an optical fiber.

15. The optical device of claim 10, the optical cable comprises a plurality of optical fibers.

16. The optical device of claim 10, the optical cable conducts laser light.

17. A method of coupling optical cables, comprising:
optically coupling a first optical cable to an optical coupling;
coupling a mechanical guide to the optical coupling, wherein the mechanical guide receives the optical cable;
optically coupling the optical coupling to a second optical device mechanically coupled to the mechanical guide; and
preventing excessive bending of the optical cable proximate to the optical device by limiting the bend radius of the first optical fiber.

18. The method of claim 17, wherein the bend radius is limited to:
not less than 20 times an outside diameter of the optical cable when the optical cable is under a tensile load condition; and
less than 10 times an outside diameter of the optical cable when the optical cable is under a no load condition.

19. The method of claim 17, wherein the optical device comprises a laser source.

20. The method of claim 17, wherein the optical device comprises a second optical cable.

21. The method of claim 17, wherein the optical device comprises a slit lamp.

22. The optical connection of claim 17, the optical cable comprises at least one optical fiber.
